(19) United States
(12) Patent Application Publication
(10) Pub. No.: US 2022/0389606 A1
(43) Pub. Date: Dec. 8, 2022

(54) CELL FOR MEASURING CONCENTRATION OF ADDITIVE BREAKDOWN PRODUCTION IN PLATING SOLUTION

(71) Applicant: Korea Institute Of Materials Science, Changwon-si, Gyeongsangnam-do (KR)

(72) Inventors: Seung-hoe CHOE, Changwon-si (KR); Myeongjin HAN, Gyeongsan-si (KR); Man KIM, Changwon-si (KR); Bung-uk YOO, Changwon-si (KR); Kyun-hwan LEE, Changwon-si (KR); Joo-yul LEE, Gimhae-si (KR); Younghwon KWAN, Gyeongju-si (KR)

(73) Assignee: Korea Institute Of Materials Science, Changwon-si, Gyeongsangnam-do (KR)

(21) Appl. No.: 17/765,101

(22) PCT Filed: Sep. 25, 2020
(86) PCT No.: PCT/KR2020/013104

§ 371 Date: Mar. 30, 2022

(30) Foreign Application Priority Data
Sep. 30, 2019 (KR) 10-2019-0120991
Jul. 9, 2020 (KR) 10-2020-0084897

(51) Int. Cl. C25D 21/12; C25D 21/18

(52) U.S. Cl. CPC C25D 21/12; C25D 21/18

(57) ABSTRACT

Provided are a measurement method, an electrochemical measuring cell, and a measuring device which are capable of directly and continuously measuring the concentration of monovalent copper ions (Cu⁺), 3-mercaptopropyl sulfonate (MPS), or Cu⁺-MPS, which is a plating additive breakdown product, in a plating solution during a copper plating process.

### TECHNICAL FIELD

The present invention relates to a cell for measuring the concentration of an additive breakdown product in a plating solution. More particularly, the present invention relates to a measurement method, an electrochemical measuring cell, and a measuring device which are capable of directly and continuously measuring the concentration of monovalent copper ions (Cu⁺), 3-mercaptopropyl sulfonate (MPS), or Cu⁺-MPS, which is a plating additive breakdown product, in a plating solution during a copper plating process.

### BACKGROUND ART

Electrolytic copper plating solutions generally contain copper sulfate, sulfuric acid, chlorine ions, and organic additives. The organic additives are added to improve plating performance, and examples thereof include an accelerator, a suppressor, and a leveler. The accelerator serves to accelerate deposition in vias and trenches during bottom-up filling. Sodium sulfopropyl disulfide (SPS) is a representative accelerator that has been used.

However, with the lapse of usage time, the performance of electrolytic copper plating solutions is degraded, causing various defects such as voids and pinholes in a plating film. The degradation of electrolytic copper plating solutions may have various causes such as the breakdown of organic additives and the introduction of impurities.

For example, in the plating solutions, breakdown products such as MPS and propane disulfonic acid (PDS) are generated from SPS due to electrochemical/chemical side reactions as shown in the following Reaction Schemes.

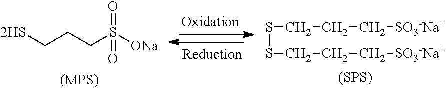

SPS²⁻+O₂+H₂O→PDS²⁻+MPS⁻+H⁺ [Reaction Scheme 2]

SPS²⁻+6H₂O→2PDS²⁻+10e⁻+12H⁺ [Reaction Scheme 3]

When the concentration of SPS in a plating solution decreases and the amounts of breakdown products such as MPS increase as such, the performance of the plating solution is degraded. Therefore, there is disclosed a method of measuring the concentration of SPS for the purpose of diagnosing plating solution performance and managing a plating solution.

Conventionally, the concentrations of SPS and MPS have been indirectly measured using a cyclic voltammetric stripping (CVS) method which is a method of analyzing a plating additive using a rotating disk electrode, by measuring cathode current which indicates the plating speed according to additive concentration and stripping charge which is proportional to the cathode current. However, this method has a problem and limitation in that the cathode electrode becomes exposed every time a sample is replaced to analyze a sample, and since the concentration of MPS is not directly measured, the method is complex and has low accuracy.

As background art of the present invention, there is disclosed Korean Patent No. 10-1711293 relating to a method of measuring the accelerator concentration of a plating solution using a cyclic voltammetry (CV) method.

### DISCLOSURE OF INVENTION

### Technical Problem

The present invention is directed to providing a method and a measuring device capable of directly and continuously quantifying an additive breakdown product contained in a plating solution during a plating process.

In addition, the present invention is directed to providing a method capable of directly and continuously measuring the concentration of monovalent copper ions (Cu⁺) in a plating solution during a plating process.

In addition, the present invention is directed to providing a method capable of directly and continuously measuring the concentration of MPS or Cu⁺-MPS, which is an additive breakdown product, in a plating solution during a plating process.

In addition, the present invention is directed to providing a method of monitoring plating solution performance which, by monitoring the performance of a plating solution in real time during a plating process, is capable of diagnosing plating defects in advance and improving plating efficiency.

In addition, the present invention is directed to providing an electrochemical measuring cell having an electrode structure capable of directly and continuously measuring the concentration of monovalent copper ions (Cu⁺), which is a plating additive breakdown product, in a plating solution during a plating process.

In addition, the present invention is directed to providing an electrochemical measuring cell having an electrode structure capable of directly and continuously measuring the concentration of MPS or Cu⁺-MPS, which is an additive breakdown product, in a plating solution during a plating process.

In addition, the present invention is directed to providing a measuring device capable of directly and continuously measuring the concentration of a plating additive in a plating solution during a plating process.

Other objectives and advantages of the present invention will be further clarified by the following detailed description of the present invention, claims, and drawings.

### Solution to Problem

One aspect of the present invention provides an electrochemical measuring cell which includes: a flow cell including a supply unit through which a plating solution is supplied and a discharge unit through which the plating solution is discharged; a working electrode coming into contact with the plating solution accommodated in the flow cell; a reference electrode coming into contact with the plating solution accommodated in the flow cell and serving as a reference in determining the electrochemical potential of the working electrode; and a counter electrode coming into contact with the plating solution accommodated in the flow cell. Here, the working electrode is an anode and includes a precious metal film, and at the working electrode, anodic current or potential is measured to identify the concentration of an additive breakdown product during a plating process.

According to one embodiment, the working electrode may be Au or a precious metal alloy thereof, or the surface thereof may be covered with a coating formed of Au or a precious metal alloy thereof or include Au or a precious metal alloy thereof in particle form.

According to one embodiment, the plating process may be a copper plating process.

According to one embodiment, a reference plating solution may include copper sulfate, sulfuric acid, and hydrochloric acid.

According to one embodiment, the additive breakdown product may be monovalent copper ions or a complex thereof.

According to one embodiment, the additive breakdown product may be MPS.

According to one embodiment, the additive breakdown product may be Cu⁺-MPS.

According to one embodiment, the additive may include SPS.

According to one embodiment, the plating solution may be directly supplied from a plating bath where plating is in progress.

According to one embodiment, in the supply unit, one or more plating solutions of a reference plating solution and a sample plating solution may be selectively supplied.

Another aspect of the present invention provides an electrochemical measuring device which includes: the electrochemical measuring cell of the present invention; and a measuring unit for measuring anodic current or potential at the working electrode to determine the concentration of an additive breakdown product in a plating solution.

According to one embodiment, the electrochemical measuring device may further include a selection valve for selectively supplying one or more of a reference plating solution and a sample plating solution.

According to one embodiment, the electrochemical measuring device may further include a control unit for controlling the supply of a plating solution to the flow cell and monitoring the performance of the plating solution by detecting an additive component of the plating solution by receiving a signal from the measuring unit.

According to one embodiment, the electrochemical measuring device may further include one or more of the flow cells and one or more measuring units paired with the flow cells.

Still another aspect of the present invention provides an electrochemical measuring system, which includes: the electrochemical measuring cell of the present invention; a measuring unit for measuring anodic current or potential at the working electrode to determine the concentration of an additive breakdown product in a plating solution; and a processing device for determining the concentration of an additive breakdown product based on the measured anodic current or potential.

### Advantageous Effects of Invention

According to one embodiment, it is possible to directly and continuously quantify an additive breakdown product contained in a plating solution during a plating process.

According to one embodiment, it is possible to directly and continuously measure the concentration of monovalent copper ions (Cu⁺), which is an additive breakdown product, in a plating solution during a plating process.

According to one embodiment, since the performance of a plating solution is monitored in real time during a plating process, it is possible to detect plating defects and improve plating efficiency.

Therefore, it is possible to diagnose the degradation of a plating solution at an early stage and thereby minimize plating defects and damage caused by the plating defects.

According to one embodiment, it is possible to directly and continuously measure the concentration of a plating additive in a plating solution during a plating process.

According to one embodiment, since a mixture of materials capable of enhancing plating additive detection signals is used, it is possible to more accurately measure the concentration of a plating additive.

According to one embodiment, since one or more flow cells and one or more measuring units are provided, it is possible to measure and analyze the concentrations of various plating additives at the same time.

### BRIEF DESCRIPTION OF DRAWINGS

FIG. 1 is a flow chart schematically illustrating a method of measuring the concentration of an additive breakdown product in a plating solution during a plating process according to one embodiment of the present invention.

FIG. 2 is an image schematically illustrating an electrochemical measuring cell having an electrode structure capable of directly and continuously measuring the concentration of a plating additive breakdown product in a plating solution during a plating process according to one embodiment of the present invention.

FIG. 3 is an image schematically illustrating the structure of an electrochemical measuring device capable of directly and continuously measuring the concentration of a plating additive in a plating solution during a plating process according to one embodiment of the present invention.

FIG. 4A is an image schematically illustrating the structure of an electrochemical measuring device capable of directly and continuously measuring the concentration of a plating additive in a plating solution during a plating process according to another embodiment of the present invention.

FIG. 4B is an image schematically illustrating the structure of an electrochemical measuring device capable of directly and continuously measuring the concentration of a plating additive in a plating solution during a plating process according to still another embodiment of the present invention.

FIG. 5A is a graph showing a change in current according to MPS concentration when the working electrode of an electrochemical measuring cell is Au.

FIG. 5B is a graph showing a change in current according to MPS concentration when the working electrode of an electrochemical measuring cell is Pt.

FIG. 5C is a graph showing a change in current according to MPS concentration when the working electrode of an electrochemical measuring cell is SUS304 stainless steel.

FIG. 6A is a graph showing a change in current according to MPS concentration when the scan speed in an electrochemical measuring device is 10 mV/s.

FIG. 6B is a graph showing a change in current according to MPS concentration when the scan speed in an electrochemical measuring device is 50 mV/s.

FIG. 6C is a graph showing a change in current according to MPS concentration when the scan speed in an electrochemical measuring device is 100 mV/s.

FIG. 7 is a graph showing a calibration curve according to MPS concentration as obtained by a method of measuring the concentration of an additive breakdown product in a plating solution according to one embodiment of the present invention.

FIG. 8A is a graph showing CV results according to MPS concentration as obtained by a method of measuring the concentration of an additive breakdown product in a plating solution according to one embodiment of the present invention.

FIG. 8B is a graph showing current according to MPS concentration as measured by a method of measuring the concentration of an additive breakdown product in a plating solution according to one embodiment of the present invention.

FIG. 9A is a graph showing the result of analyzing, after adding SPS or polyethylene glycol (PEG) to a plating solution, the degradation of the plating solution based on a change in current according to an electrochemical potential as obtained by a method of measuring the concentration of an additive breakdown product in the plating solution according to one embodiment of the present invention.

FIG. 9B is a graph showing the result of analyzing, after adding SPS and PEG to a plating solution, the degradation of the plating solution based on a change in current over time as obtained by a method of measuring the concentration of an additive breakdown product in the plating solution according to one embodiment of the present invention.

FIG. 10A is a graph showing the result of measuring current over time as obtained by a method of measuring the concentration of an additive breakdown product in a plating solution according to one embodiment of the present invention.

FIG. 10B is a graph showing MPS concentration over time as measured using a calibration curve derived by a method of measuring the concentration of an additive breakdown product in a plating solution according to one embodiment of the present invention.

FIGS. 11A and 11B are graphs showing the result of measuring the concentration of SPS in an unknown sample according to one embodiment of the present invention.

FIGS. 12A and 12B are graphs showing the result of measuring the concentration of a leveler in an unknown sample according to one embodiment of the present invention.

### MODE FOR THE INVENTION

The objectives, specific advantages, and novel features of the present invention will become more apparent from the following detailed description associated with the accompanying drawings and exemplary embodiments.

First, terms or words used in the present specification and claims should not be interpreted in a conventional and lexical sense and should be interpreted as meanings and concepts consistent with the technical spirit of the present invention based on the principle that the inventor can adequately define the concept of terms in order to best explain his or her own invention.

In the present specification, when a first component such as a layer, part, or substrate is described as being “on,” “connected to,” or “joined with” a second component, the first component may be “on,” “connected to,” or “joined with” the second component directly or through one or more other components interposed therebetween. On the other hand, when a first component is described as being “directly on,” “directly connected to,” or “directly joined with” a second component, no other components are interposed therebetween.

The terms used in the present specification are only used to describe specific exemplary embodiments and are not intended to limit the present specification. Singular forms may include plural forms unless the context clearly indicates otherwise.

In the present specification, it should be understood that the terms such as “include” or “have” are intended to indicate the presence of features, numbers, steps, operations, components, or parts described in the specification or a combination thereof and do not preclude the possibility of the presence or addition of one or more other features, numbers, steps, operations, components, parts, or a combination thereof.

In the present specification, when a certain part is described as “including” a certain component, it does not preclude the possibility of the presence of other components and means that the part may further include other components unless otherwise stated. In addition, throughout the specification, when a component is described as being located “on” a reference component, it means that the component is located above or below the reference component, and does not necessarily mean that the component is located above the reference component in a gravitational sense.

While the present invention can have various modifications and various exemplary embodiments, specific exemplary embodiments thereof will be illustrated in the drawings and described in the detailed description. However, the specific exemplary embodiments are not intended to limit the present invention thereto and should be understood as including all modifications, equivalents, and substitutes included in the spirit and technical scope of the present invention. In describing the present invention, when it is determined that a detailed description of related known techniques may obscure the gist of the present invention, the detailed description will be omitted.

Hereinafter, exemplary embodiments of the present invention will be described in detail with reference to the accompanying drawings, and in describing the exemplary embodiments with reference to the accompanying drawings, identical or similar components will be given the same reference numerals, and repeated descriptions thereof will be omitted.

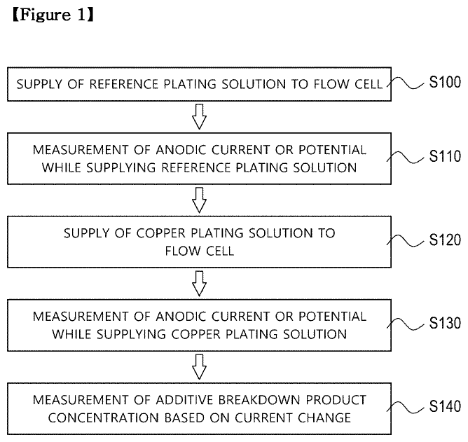

FIG. 1 is a flow chart schematically illustrating a method of measuring the concentration of an additive breakdown product in a plating solution during a plating process according to one embodiment of the present invention.

As shown in FIG. 1, a method of measuring the concentration of an additive breakdown product in a copper plating solution of the present invention includes the steps of:

I-i) supplying a reference plating solution to a flow cell (S100);

I-ii) measuring the anodic current or potential of the reference plating solution (S110);

I-iii) supplying a plating solution containing an additive to the flow cell (S120);

I-iv) measuring the anodic current or potential of the plating solution (S130); and

I-v) measuring the concentration of an additive breakdown product in a plating solution based on a change in the anodic current or a change in the potential (S140).

In S100, the reference plating solution may include copper sulfate, sulfuric acid, and hydrochloric acid. Although not limited thereto, the amount of copper ions may be in the range of 2 g/L to 250 g/L, and the amount of sulfuric acid may be in the range of 10 g/L to 200 g/L. The amount of chlorine ions may be in the range of 1 mg/L to 1 g/L. The optimum amount of each component may be adjusted in consideration of the performance of a copper plating solution. Although not limited thereto, the flow cell may be a micro flow cell.

In S110, the anodic current may be measured using a known technique. It is necessary to measure the anodic current of the reference plating solution to minimize the error resulting from the current related to adsorption of chemical species and detect even a very small change in current.

In S110, the potential may be measured using a known technique. Although not limited thereto, the potential may be measured using chronopotentiometry.

In S120, the copper plating solution containing an additive may be supplied from a plating bath where plating is in progress. With this configuration, it is possible to continuously monitor the performance of the plating bath in real time.

Unlike in the conventional art where the concentration of an additive is indirectly identified by way of measuring the rates of copper ion (Cu²⁺) reduction and oxidation according to the additive concentration, since the oxidation reaction of a material to be analyzed is directly induced and anodic current is measured in the present invention, it is possible to solve the problem that the breakdown ability is degraded due to a change in the concentration of other materials in the sample.

The concentration of the additive breakdown product may be the concentration of monovalent copper ions.

Unlike in the conventional art, the anode current of a working electrode is directly measured in the method of the present invention, and it is possible to directly measure the concentration of monovalent copper ions in the plating solution supplied to the flow cell.

The additive may be SPS, and the breakdown product may be MPS or Cu⁺-MPS.

Unlike in the conventional art where the concentration of MPS is deduced from the measured amount of SPS, since it is possible to directly measure the concentration of MPS, which is a breakdown product of SPS, in the present invention, it is possible to more accurately monitor the performance of a copper plating solution.

In the present invention, the method of measuring a change in current is not particularly limited as long as it can measure the Faraday current. Although not limited thereto, chronoamperometry, slow scan linear sweep voltammetry (LSV), or slow scan cyclic voltammetry (CV) may be used. However, it may be difficult to analyze the bath using fast scan LSV, chronopotentiometry, or open circuit potential (OCP).

Although not limited thereto, when measuring the change in current, it may be suitable that the scan speed is in the range of 1 to 50 mV/s. When the scan speed exceeds 50 mV/s, since charging current acting as noise increases, it may be difficult to calculate a calibration curve.

Using the calibration curve calculated in step I-v), it is possible to measure the concentration of an additive breakdown product in a copper plating solution based on a change in the anodic current or a change in the potential.

With this configuration, it is possible to accurately and quickly measure the concentration of an additive breakdown product in a copper plating solution.

The method of calculating the calibration curve may include the following steps:
supplying a reference plating solution to the flow cell and then measuring current by applying an electrochemical potential;
after a certain period of time, supplying a copper plating solution containing an additive to the flow cell through a selection valve and measuring current by applying an electrochemical potential; and
supplying a reference plating solution to the flow cell and then measuring current by applying an electrochemical potential, wherein, in this step, the calibration curve may be calculated using peak current or a peak area according to the additive concentration.

In addition, the method of calculating the calibration curve may include the following steps:
supplying a reference plating solution to the flow cell and then measuring current by applying a predetermined range of an electrochemical potential and scanning the electrochemical potential; and
supplying a copper plating solution containing an additive to the flow cell through a selection valve and measuring current by scanning the electrochemical potential, wherein, in this step, the calibration curve may be calculated using the current density according to the additive concentration at a predetermined electrochemical potential.

Although not limited thereto, it may be suitable that the electrochemical potential scan range is 0.3 V to 1.2 V (vs. Ag/AgCl (sat. KCl)). This is because side reactions which may occur outside this electrochemical potential range may increase measurement errors. For example, at an electrochemical potential of less than 0.3 V (vs. Ag/AgCl (sat. KCl)), the reduction of divalent copper may increase measurement errors, and at an electrochemical potential of more than 1.2 V (vs. Ag/AgCl (sat. KCl)), the oxidation of an electrode and the breakdown of water may increase measurement errors.

The method of monitoring the performance of a copper plating solution according to the present invention may include the following steps:

II-i) supplying a reference plating solution to a flow cell;

II-ii) measuring the anodic current or potential of the reference plating solution;

II-iii) supplying, to the flow cell, a plating solution containing an additive used in a plating process;

II-iv) measuring the anodic current or potential of the plating solution;

II-v) measuring the concentration of an additive breakdown product in the plating solution based on a change in the anodic current or a change in the potential; and

II-vi) evaluating the performance of the plating solution based on the measured additive breakdown product concentration.

The copper plating solution may be directly supplied from a plating bath where plating is in progress.

With the configuration of the present invention, it is possible to directly, accurately, and continuously monitor the performance of a copper plating solution.

The plating solution may also be supplied after being collected from the plating bath to be analyzed.

The method of monitoring copper plating solution performance according to the present invention may further include step II-vii) adding an additive based on a change in the anodic current or a change in the potential.

With this configuration of the present invention, since the degradation of a plating solution can be diagnosed at an early stage, it is possible to optimally maintain the performance of the plating solution and minimize plating defects and damage caused by the plating defects.

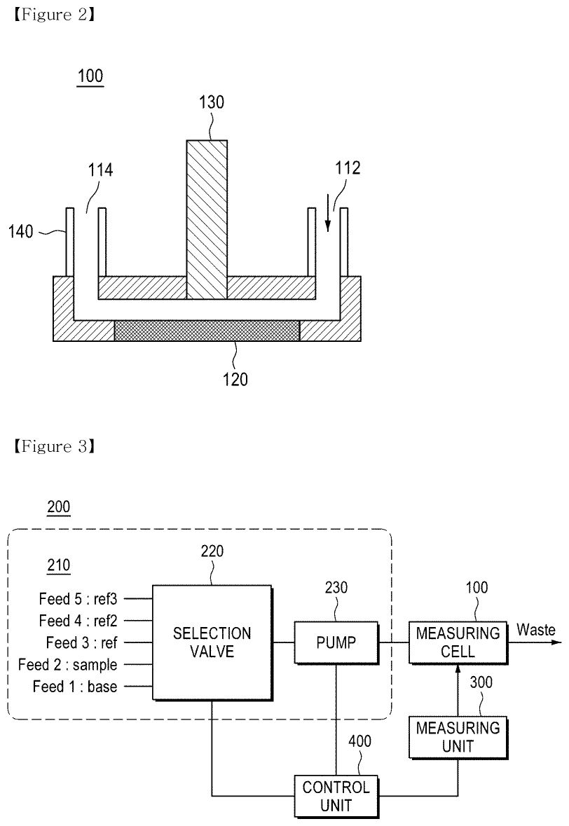

FIG. 2 is an image schematically illustrating an electrochemical measuring cell having an electrode structure capable of directly and continuously measuring the concentration of a plating additive breakdown product in a plating solution during a plating process according to one embodiment of the present invention.

Referring to FIG. 2, the electrochemical measuring cell 100 of the present invention includes a flow cell including a supply unit 112 through which a plating solution is supplied and a discharge unit 114 through which the plating solution is discharged; a working electrode 120 coming into contact with the plating solution accommodated in the flow cell; a reference electrode 130 coming into contact with the plating solution accommodated in the flow cell and serving as a reference in determining the electrochemical potential of the working electrode 120; and a counter electrode 140 coming into contact with the plating solution accommodated in the flow cell.

The working electrode 120 is an electrode for exchanging electrons with a chemical species in an electrolytic copper plating solution.

The working electrode 120 is an anode and includes a precious metal film, and at the electrode, anodic current is measured to identify the concentration of an additive breakdown product during a copper plating process.

Using this configuration, in the method of the present invention, the anodic current of the working electrode 120 is directly measured unlike in the conventional art, and it is possible to directly measure the concentrations of monovalent copper ions, MPS, and/or Cu⁺-MPS in a plating solution supplied to the flow cell.

The working electrode 120 employs the concept of an electrochemically active surface area (ECSA), and it is more preferable that the working electrode is in the form of a film rather than having a porous structure.

The working electrode 120 may be Au or a precious metal alloy thereof, or the surface thereof may be covered with a coating formed of Au or a precious metal alloy thereof or include Au or a precious metal alloy thereof in nanoparticle form.

Although not limited thereto, the working electrode 120 is preferably an electrode in the form of a film formed of Au or a precious metal alloy thereof such as Au—Pt, Au—Pd, Au—Ru, or Au—Ir; an electrode in the form of an Au/Pt, Au/Pd, Au—Ru, or Au/Ir film whose surface contacting a plating solution is Au; or an electrode in the form in which a precious metal film surface contacting a plating solution is covered with or includes Au nanoparticles. With this configuration, since electrocatalytic activity is excellent and current density is high, an additive breakdown product can be accurately and quickly quantified.

The working electrode 120 may be electrically connected to a current generating unit at the same time as being connected to a conducting wire.

The reference electrode 130 is an electrode serving as a reference in determining the electrochemical potential of the working electrode 120. As the material of the reference electrode 130, for example, saturated calomel (Hg/Hg₂Cl₂), silver/silver chloride (Ag/AgCl), or the like may be used.

The counter electrode 140 is an electrode which, together with the working electrode 120, causes electricity to flow in an electrolytic copper plating solution, and is an electrode for causing a reaction at the interface between the electrode and the electrolytic copper plating solution. As the counter electrode 140, for example, a soluble electrode such as a copper electrode or an insoluble electrode such as a platinum, SUS, iridium, iridium oxide, coated titanium electrode, or the like may be used.

The additive may be SPS, and the breakdown product may be MPS or Cu⁺-MPS.

In the conventional art, the concentrations of SPS and MPS are only deduced based on accelerating effects of SPS and MPS on the reduction of Cu²⁺. On the other hand, in the present invention, it is possible to directly measure the concentration of MPS, which is an SPS breakdown product, and thereby more accurately monitor the performance of a copper plating solution.

The copper plating solution containing an additive may be supplied from a plating bath where plating is in progress. With this configuration, it is possible to continuously monitor the performance of the plating bath in real time.

FIG. 3 is an image schematically illustrating the structure of an electrochemical measuring device capable of directly and continuously measuring the concentration of a plating additive in a plating solution during a plating process according to one embodiment of the present invention.

Referring to FIG. 3, the electrochemical measuring device of the present invention largely consists of a supply member 200, a measuring cell 100, a measuring unit 300, and a control unit 400.

The supply member 200 consists of supply lines 210 for a reference plating solution, a sample plating solution, and the like; a selection valve 220 capable of selectively supplying a plating solution and the like; and a pump 230 for guiding a plating solution and the like into the measuring cell 100.

The supply member 200 enables a base solution, a sample, a plating solution sample, a reference plating solution, and the like having different compositions to be continuously supplied to the measuring unit 300 without exposing the electrode to the air. With this configuration, it is possible to reduce an error caused by the exposure of the electrode to the air and more accurately measure the concentration of a target material.

Referring to FIG. 2, the measuring cell 100 may include a flow cell including a supply unit 112 through which a plating solution and the like supplied through the selection valve 220 are supplied and a discharge unit 114 through which the supplied plating solution is discharged; a working electrode 120 coming into contact with the plating solution accommodated in the flow cell; a reference electrode 130 coming into contact with the plating solution accommodated in the flow cell and serving as a reference in determining the electrochemical potential of the working electrode 120; and a counter electrode 140 coming into contact with the plating solution accommodated in the flow cell. The working electrode 120 is an anode and includes a precious metal film, and at the working electrode 120, anodic current is measured to detect an additive component of the plating solution.

Between the working electrode 120 and the counter electrode 140, a current generating unit for allowing current to flow at constant current density may be provided.

The measuring unit 300 may detect a change in the current of the working electrode 120.

The control unit 400 may control the supply of a plating solution to the flow cell, and may detect an additive component of the plating solution by receiving a signal from the measuring unit 300 and thereby monitor the performance of the plating solution. With this configuration, it is possible to diagnose the degradation of a plating solution at an early stage and maintain the optimum performance of the plating solution and thereby minimize plating defects and damage caused by the plating defects.

The control unit 400 may control the addition of an additive component into the plating solution. With the configuration of the present invention, it is possible to diagnose the degradation of the plating solution at an early stage and maintain the optimum performance of the plating solution and thereby minimize plating defects and damage caused by the plating defects.

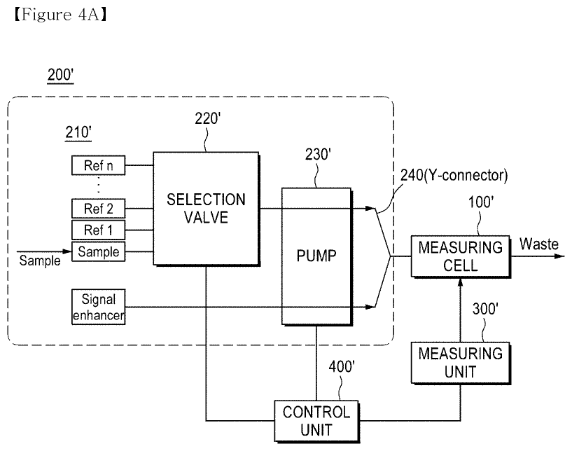

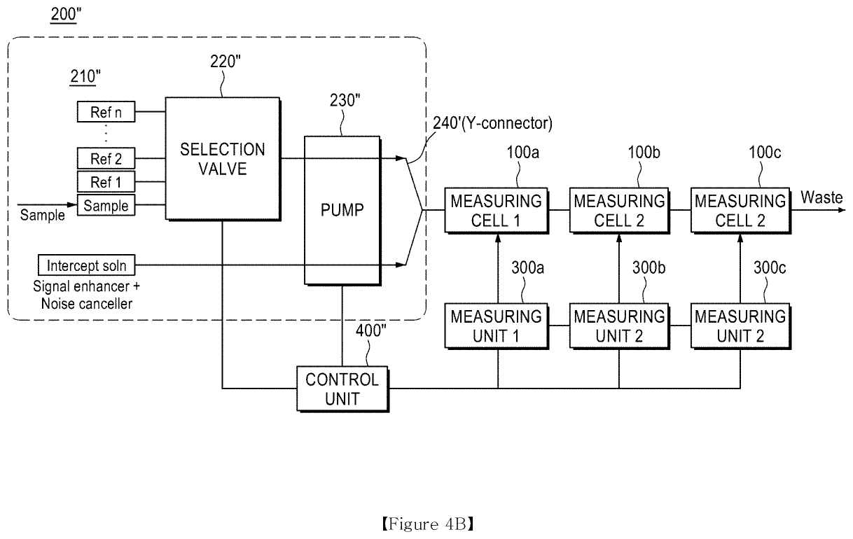

FIG. 4A is an image schematically illustrating the structure of an electrochemical measuring device capable of directly and continuously measuring the concentration of a plating additive in a plating solution during a plating process according to another embodiment of the present invention. FIG. 4B is an image schematically illustrating the structure of an electrochemical measuring device capable of directly and continuously measuring the concentration of a plating additive in a plating solution during a plating process according to still another embodiment of the present invention.

The electrochemical measuring device of FIG. 4A is different from the electrochemical measuring device of FIG. 3 in that the pump 230′ is a multi-channel pump and a Y-connector 240 is further provided. Hereinafter, detailed descriptions of duplicate configurations will be omitted.

With this configuration, it is possible to supply one or more of a signal enhancer capable of enhancing detection signals and a noise-reducing agent capable of removing the noise of detection signals to the flow cell, along with one or more of a reference plating solution and a sample plating solution.

The electrochemical measuring device of FIG. 4B is different from the electrochemical measuring device of FIG. 4A in that one or more of the flow cells 100a, 100b, 100c and one or more measuring units 300a, 300b, 300c paired with the flow cells are further included. Hereinafter, detailed descriptions of duplicate configurations will be omitted.

With this configuration, since one or more flow cells and one or more measuring units are provided, it is possible to measure and analyze the concentrations of various plating additives at the same time.

The additive may be one or more of an accelerator, a suppressor, and a leveler. With this configuration, it is possible to directly, continuously, and accurately measure the concentrations of various additives.

Hereinafter, the present invention will be described in more detail by way of exemplary embodiments. However, these exemplary embodiments are merely illustrative of the present invention and should not be construed as limiting the scope of the present invention.

### EXAMPLES

### 1. Quantification of Additive Breakdown Products in Plating Solution According to Working Electrode

### 1) Example 1 and Comparative Examples 1 and 2

The anodic current was measured while varying the working electrode for the electrochemical measuring cell of the present invention. When measuring the anodic current, the same experimental conditions and procedures were used except that an Au electrode was used as a working electrode in Example 1, a Pt electrode was used as a working electrode in Comparative Example 1, and a SUS304 stainless steel electrode was used as a working electrode in Comparative Example 2.

### 2) Experimental Conditions

(1) Flow rate: 2 mL/min,

(2) Blank electrolyte: 0.5 M H₂SO₄

(3) Measuring cell structure: See FIG. 2

(4) Voltammetry scan range: 0.3 V to 1.2 V

(5) Scan rate: 10 mV/s

(6) Working electrode: Au, Pt, SUS

(7) Counter electrode: SUS304

(8) Reference electrode: Ag/AgCl (sat. KCl)

### 3) Experimental Procedures

(1) The selection valve was adjusted to allow the blank electrolyte to flow into the micro flow cell.

(2) After maintaining the OCP mode for 60 seconds, an electrochemical potential was scanned within the range of 0.3 V to 1.2 V (vs. Ag/AgCl).

(3) After the scan was completed, 25 μM MPS and 0.5 M H₂SO₄ solutions were flowed into the micro flow cell using the selection valve.

(4) An electrochemical potential was scanned within the range of 0.3 V to 1.2 V (vs. Ag/AgCl).

(5) Steps (3) and (4) were repeated for various electrolytes having different MPS concentrations.

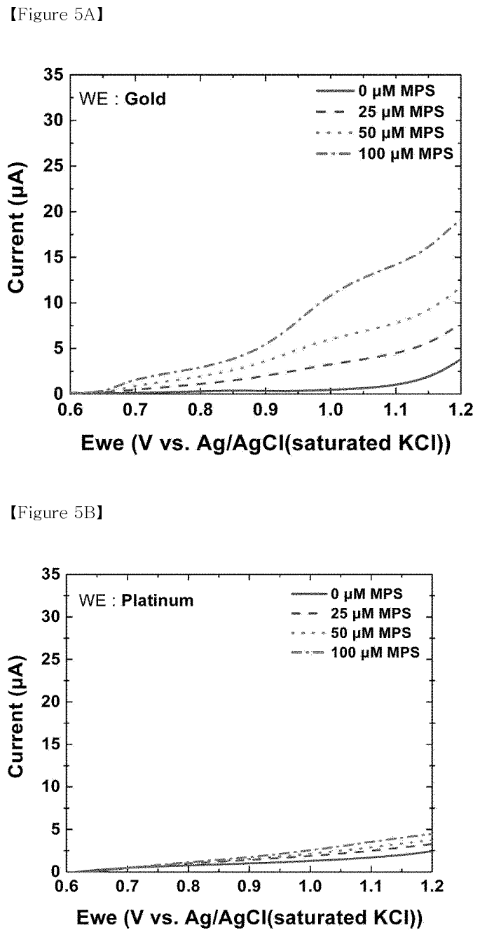

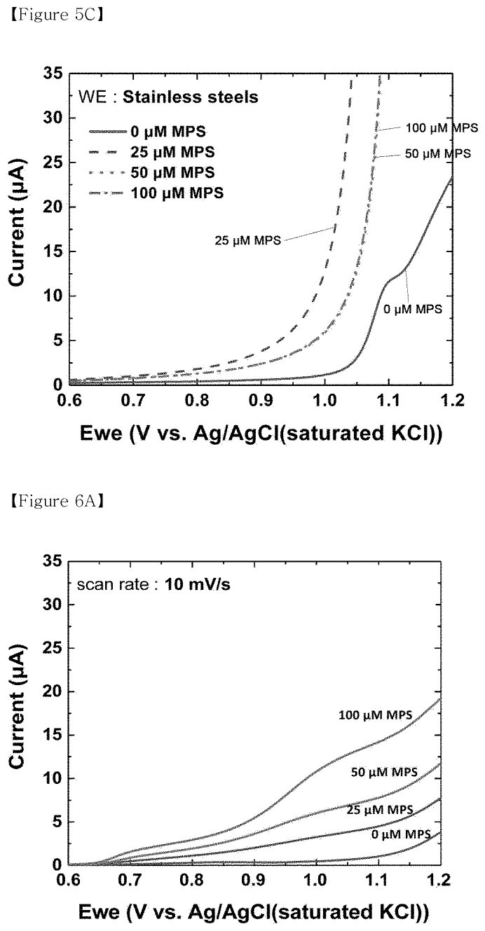

The experimental results are shown in FIGS. 5A to 5C. FIG. 5A is a graph showing a change in current according to MPS concentration when the working electrode of an electrochemical measuring cell is Au, FIG. 5B is a graph showing a change in current according to MPS concentration when the working electrode of an electrochemical measuring cell is Pt, and FIG. 5C is a graph showing a change in current according to MPS concentration when the working electrode of an electrochemical measuring cell is SUS304 stainless steel.

Referring to FIGS. 5A to 5C, in the case of Example 1 where an Au electrode was used as a working electrode, an electrocatalytic activity for thiol oxidation was exhibited, which resulted in high current density. Therefore, the electrode of Example 1 is useful as a working electrode.

On the other hand, in the case of Comparative Example 1 where a Pt electrode was used as a working electrode, although a precious metal like Au was used, it was found that since a large electrocatalytic activity for thiol oxidation was not exhibited, the electrode is not useful as a working electrode.

In addition, in the case of Comparative Example 2 where a SUS electrode was used as a working electrode, it was found that since no electrocatalytic activity for thiol oxidation was exhibited and corrosion current was generated in the relevant electrochemical potential range and acted as noise, the electrode may be not useful as a working electrode.

### 2. Quantification of Additive Breakdown Products in Plating Solution According to Scan Speed

### 1) Example 2 and Comparative Examples 3 and 4

The anodic current was measured using the electrochemical measuring device of the present invention while varying a scan speed. When measuring the anodic current, the same experimental conditions and procedures were used except that a scan speed of 10 mV/s was used in Example 2, a scan speed of 50 mV/s was used in Comparative Example 3, and a scan speed of 100 mV/s was used in Comparative Example 4.

### 2) Experimental Conditions

(1) Flow rate: 2 mL/min

(2) Blank electrolyte: 0.5 M H₂SO₄

(3) Measuring cell structure: See FIG. 2

(4) Voltammetry scan range: 0.3 V to 1.2 V

(5) Scan rate: 10 mV/s to 100 mV/s

(6) Working electrode: Au

(7) Counter electrode: SUS304

(8) Reference electrode: Ag/AgCl (sat. KCl)

### 3) Experimental Procedures

(1) The selection valve was adjusted to allow the blank electrolyte to flow into the micro flow cell.

(2) An electrochemical potential was scanned within the range of 0.3 V to 1.2 V (vs. Ag/AgCl).

(3) After the scan was completed, 25 μM MPS and 0.5 M H₂SO₄ solutions were flowed into the micro flow cell using the selection valve.

(4) An electrochemical potential was scanned within the range of 0.3 V to 1.2 V (vs. Ag/AgCl).

(5) Steps (3) and (4) were repeated for various electrolytes having different MPS concentrations.

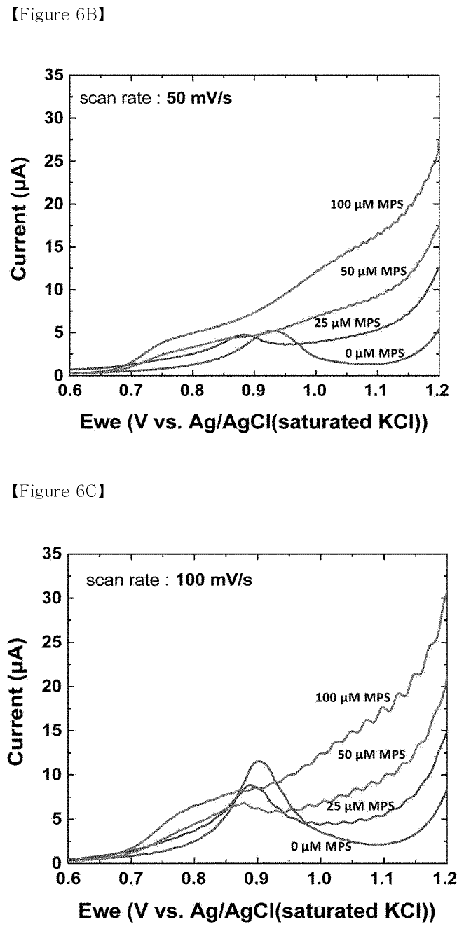

The experimental results are shown in FIGS. 6A to 6C. FIG. 6A is a graph showing a change in current according to MPS concentration when the scan speed in an electrochemical measuring device is 10 mV/s. FIG. 6B is a graph showing a change in current according to MPS concentration when the scan speed in an electrochemical measuring device is 50 mV/s. FIG. 6C is a graph showing a change in current according to MPS concentration when the scan speed in an electrochemical measuring device is 100 mV/s.

Referring to FIGS. 6A to 6C, it was found that when the scan speed was increased to 50 mV/s or more (Comparative Examples 3 and 4), the magnitude of charging current, which is noise, increased, making it difficult to calculate a calibration curve.

### 3. Calibration Curve Calculation Method I

A calibration curve was calculated using the following experimental conditions and experimental procedures.

### 1) Experimental Conditions

(1) Flow rate: 2 mL/min

(2) Blank electrolyte: 0.5 M H₂SO₄

(3) Measuring cell structure: See FIG. 2

(4) Working electrode: Au

(5) Counter electrode: SUS304

(6) Reference electrode: Ag/AgCl (sat. KCl)

### 2) Experimental Procedures

(1) The selection valve was adjusted to allow the blank electrolyte to flow into the micro flow cell.

(2) A voltage of 1.1 V (vs. Ag/AgCl (sat. KCl)) was applied.

(3) Current such as charging current was allowed to initially flow and maintained until stabilized.

(4) After 60 seconds had passed, 25 μM MPS and 0.5 M H₂SO₄ solutions were flowed into the micro flow cell using the selection valve.

(5) The current density increased due to MPS in the electrolyte.

(6) After 60 seconds had passed, a blank solution was flowed into the micro flow cell using the selection valve.

(7) Steps (4) to (6) were repeated for various electrolytes having different MPS concentrations.

(8) Using the resulting peak current or peak area, a calibration curve was calculated.

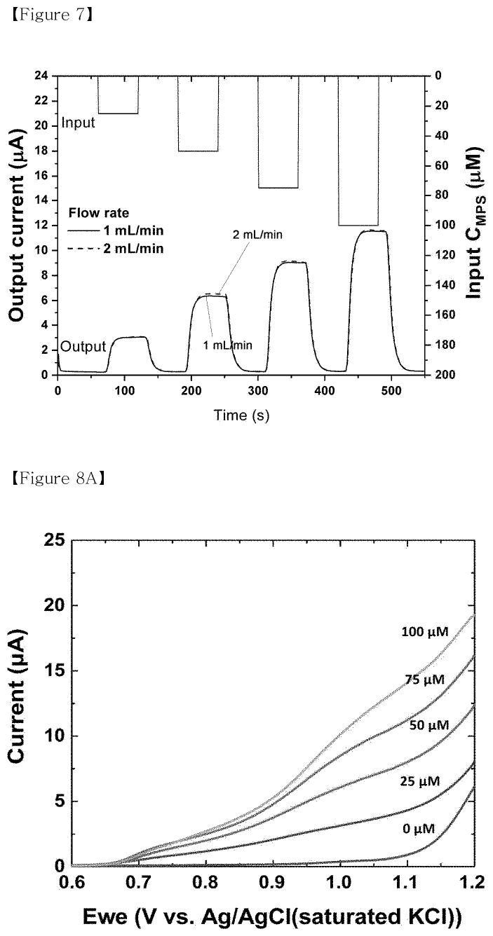

The results are shown in FIG. 7. FIG. 7 is a graph showing a calibration curve according to MPS concentration as obtained by a method of measuring the concentration of an additive breakdown product in a plating solution according to one embodiment of the present invention. As shown in FIG. 7, it was possible to calculate a calibration curve by the above-described process.

### 4. Calibration Curve Calculation Method II

In another method, a calibration curve was calculated using the following experimental conditions and experimental procedures.

### 1) Experimental Conditions

(1) Flow rate: 2 mL/min

(2) Blank electrolyte: 0.5 M H₂SO₄

(3) Measuring cell structure: See FIG. 2

(4) Working electrode: Au

(5) Counter electrode: SUS304

(6) Reference electrode: Ag/AgCl (sat. KCl)

### 2) Experimental Procedures

(1) The selection valve was adjusted to allow the blank electrolyte to flow into the micro flow cell.

(2) After maintaining the OCP mode for 60 seconds, an electrochemical potential was scanned within the range of 0.3 V to 1.2 V (vs. Ag/AgCl).

(3) After the scan was completed, 25 μM MPS and 0.5 M H₂SO₄ solutions were flowed into the micro flow cell.

(4) An electrochemical potential was scanned within the range of 0.3 V to 1.2 V (vs. Ag/AgCl).

(5) Steps (3) and (4) were repeated for various electrolytes having different MPS concentrations.

(6) Using the current density generated at a specific potential, a calibration curve was calculated.

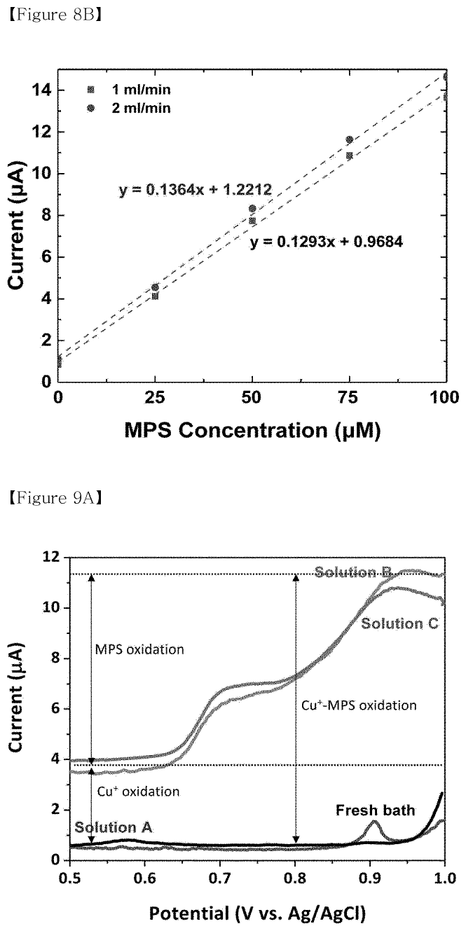

The results are shown in FIGS. 8A and 8B. FIG. 8A is a graph showing CV results according to MPS concentration as obtained by a method of measuring the concentration of an additive breakdown product in a plating solution according to one embodiment of the present invention, and FIG. 8B is a graph showing current density according to MPS concentration as measured by a method of measuring the concentration of an additive breakdown product in a plating solution according to one embodiment of the present invention. As shown in FIGS. 8A and 8B, it was possible to calculate a calibration curve by the above-described process.

### 4. Plating Solution Degradation Analysis I

In the method of the present invention, the degradation of a plating solution was analyzed using the following experimental conditions and experimental procedures.

### 1) Experimental Conditions

(1) Flow rate: 1.7 mL/min,

(2) Working electrode: Au,

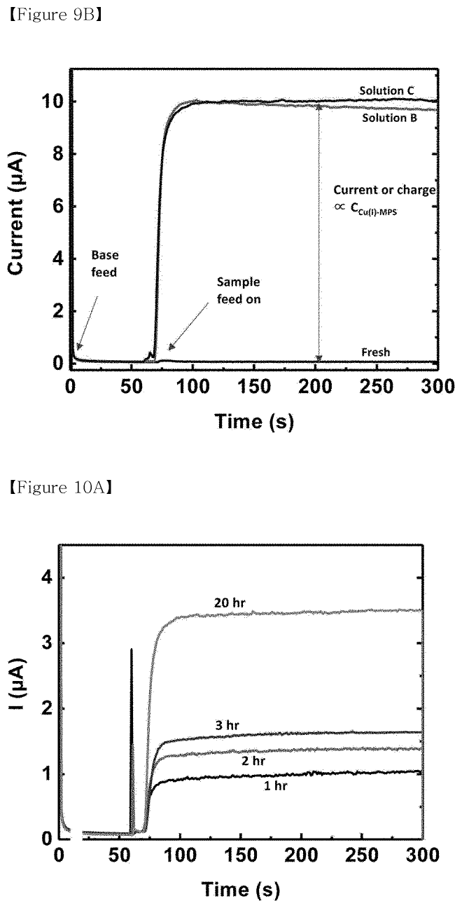

(3) Scan rate (LSV analysis (FIG. 9A)): 10 mV/s; Applied potential (CA analysis (FIG. 9B)): 0.9 V

(4) Blank electrolyte: 0.8 M CuSO₄, 0.5 M H₂SO₄, and 1 mM HCl

(5) Electrolyte to be analyzed:

>Initial compositions:

(A) 1.0 M CuSO₄, 0.5 M H₂SO₄, and 1 mM HCl

(B) 1.0 M CuSO₄, 0.5 M H₂SO₄, 1 mM HCl, and 500 μM SPS

(C) 1.0 M CuSO₄, 0.5 M H₂SO₄, 1 mM HCl, 500 μM SPS, and 3 g/L PEG (MW: 1,500)

>Degradation conditions:
Three 100 mL solutions were provided.
A 20 cm² phosphorus copper electrode was immersed in each solution.
The condition was maintained for 20 hours.
Analysis was performed using the device of the present invention.

The results are shown in FIGS. 9A and 9B. FIG. 9A is a graph showing the result of analyzing, after adding SPS or PEG to a plating solution, the degradation of the plating solution based on a change in current density according to an electrochemical potential as obtained by a method of measuring the concentration of an additive breakdown product in the plating solution according to one embodiment of the present invention. FIG. 9B is a graph showing the result of analyzing, after adding SPS or PEG to a plating solution, the degradation of the plating solution based on a change in current density over time as obtained by a method of measuring the concentration of an additive breakdown product in the plating solution according to one embodiment of the present invention.

As shown in FIGS. 9A and 9B, as the SPS was broken down by the phosphorus copper electrode, Cu(I)-MPS was produced. The current density caused by Cu(I)-MPS was detected. The current density change caused by the co-added PEG was negligible.

### 5. Plating Solution Degradation Analysis II

In the method of the present invention, the degradation of a plating solution was analyzed using the following experimental conditions and experimental procedures.

### 1) Experimental Conditions

(1) Flow rate: 1.7 mL/min,

(2) Working electrode: Au,

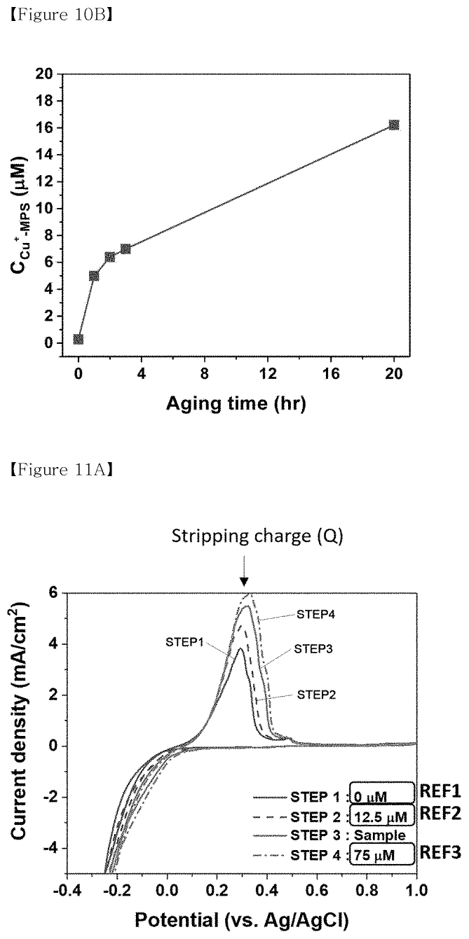

(3) Applied potential (CA analysis (FIG. 10B)): 0.9 V

(4) Blank electrolyte: 0.8 M CuSO₄, 0.5 M_{H2SO4}, and 1 mM HCl

(5) Electrolyte to be analyzed:

>Initial Compositions:

A) 1.0 M CuSO₄, 0.5 M H₂SO₄, 1 mM HCl, and a commercially available additive (a combination of an accelerator, a suppressor, and a leveler and containing SPS)

### 2) Experimental Procedures

(1) A 100 mL solution was provided.

(2) A 20 cm² phosphorus copper electrode was immersed in the solution.

(3) The condition was maintained for 20 hours.

(4) Analysis was performed using the measuring device of the present invention.

(5) Using the prepared calibration curve, concentration was measured.

The results are shown in FIGS. 10A and 10B. FIG. 10A is a graph showing the result of measuring current over time as obtained by a method of measuring the concentration of an additive breakdown product in a plating solution according to one embodiment of the present invention. FIG. 10B is a graph showing MPS concentration over time as measured using a calibration curve derived by a method of measuring the concentration of an additive breakdown product in a plating solution according to one embodiment of the present invention.

As shown in FIGS. 10A and 10B, it was found that with the lapse of plating time, the concentration of Cu⁺-MPS increased, and the plating solution was degraded.

### 6. Measurement of SPS Concentration in Unknown Sample

In order to measure the concentration of SPS in an unknown sample by the method of the present invention, the following experimental conditions and experimental procedures were used.

### 1) Experimental Conditions

(1) Sample: 0.8 M CuSO₄, 0.5 M H₂SO₄, 1.4 mM HCl, and a combination of commercially available additives of unknown concentrations

(2) Signal enhancer: 0.8 M CuSO₄, 0.5 M H₂SO₄, 1.4 mM HCl, 1 g/L PEG-500, 1 g/L PEG-1000, and 1 g/L PEG-4000

(3) REF1: 0.8 M CuSO₄, 0.5 M H₂SO₄, and 1.4 mM HCl

(4) REF2: 0.8 M CuSO₄, 0.5 M H₂SO₄, 1.4 mM HCl, and 12.5 μM SPS

(5) REF3: 0.8 M CuSO₄, 0.5 M H₂SO₄, 1.4 mM HCl, and 75 μM SPS

### 2) Experimental Procedures

(1) A system as shown in FIG. 4A was configured.

(2) The selection valve was set for the input of a REF1 solution.

(3) The flow rate of REF was adjusted to 0.5 mL/min, and the flow rate of a carrier was adjusted to 1.5 mL/min.

(4) CVS analysis was performed within the range of 1.0 V to −0.25 V at a scan rate of 50 mV/s. To ensure electrode conditioning and reproducibility, this step was carried out three times in succession.

(5) After setting the selection valve for the input of a REF2 solution, step (3) was repeated.

(6) After setting the selection valve for the input of a sample solution to be analyzed, step (3) was repeated.

(7) After setting the selection valve for the input of REF3, step (3) was repeated.

(8) By analyzing the stripping charge (Q) obtained in steps (3) to (6), the concentration of the accelerator in the target plating solution was determined. In this case, the following equations were used.

1/C_{SPS}=(y−d) (c−a)/(d−b)+c

y=1/(Qₛₐₘₚₗₑ−Q_{REF1})

a=1/C_{SPS,REF3}

b=1/(Q_{REF3}−Q_{REF1})

c=1/C_{SPS,REF2}

d=1/(Q_{REF2}−Q_{REF1})

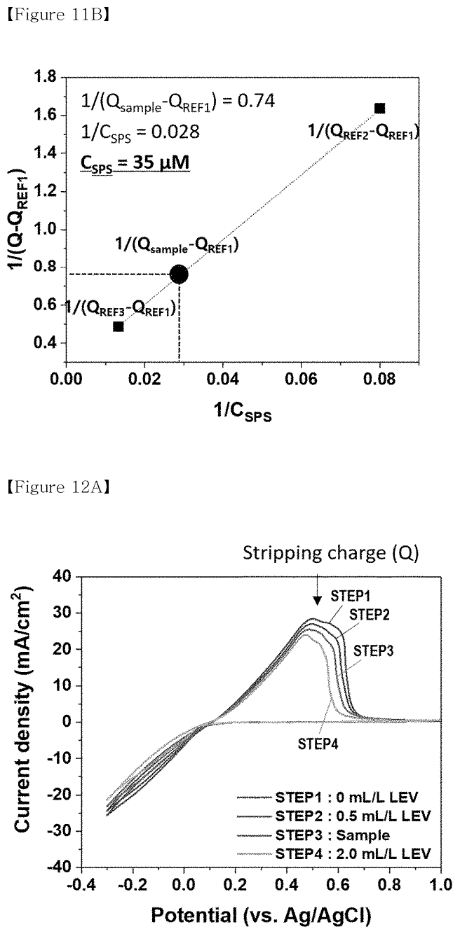

The results are shown in FIGS. 11A and 11B. FIGS. 11A and 11B are graphs showing the result of measuring the concentration of SPS in an unknown sample according to one embodiment of the present invention.

### 7. Measurement of Leveler Concentration in Unknown Sample

In order to measure the concentration of a leveler in an unknown sample by the method of the present invention, the following experimental conditions and experimental procedures were used.

### 1) Experimental Conditions

(1) Sample: 0.8 M CuSO₄, 0.5 M H₂SO₄, 1.4 mM HCl, and a combination of commercially available additives of unknown concentrations

(2) Signal enhancer: 0.8 M CuSO₄, 0.5 M H₂SO₄, 1.4 mM HCl, 1 g/L PEG-500, 1 g/L PEG-1000, 1 g/L PEG-4000, and 500 μM SPS

(3) REF1: 0.8 M CuSO₄, 0.5 M H₂SO₄, 1.4 mM HCl, and 500 μM SPS

(4) REF2: 0.8 M CuSO₄, 0.5 M H₂SO₄, 1.4 mM HCl, 500 μM SPS, and a 0.5 mL/L leveler

(5) REF3: 0.8 M CuSO₄, 0.5 M H₂SO₄, 1.4 mM HCl, 500 μM SPS, and a 2.0 mL/L leveler

### 2) Experimental Procedures

(1) A system as shown in FIG. 4A was configured.

(2) The selection valve was set for the input of a REF1 solution.

(3) The flow rate of REF was adjusted to 0.5 mL/min, and the flow rate of a carrier was adjusted to 1.5 mL/min.

(4) CVS analysis was performed within the range of 1.0 V to −0.3 V at a scan rate of 50 mV/s. To ensure electrode conditioning and reproducibility, this step was carried out three times in succession.

(5) After setting the selection valve for the input of a REF2 solution, step (3) was repeated.

(6) After setting the selection valve for the input of a sample solution to be analyzed, step (3) was repeated.

(7) After setting the selection valve for the input of REF3, step (3) was repeated.

(8) By analyzing the stripping charge (Q) obtained in steps (3) to (6), the concentration of the leveler in the target plating solution was determined. In this case, the following equations were used.

1/C_{LEV}=(y−d) (c−a)/(d−b)+c

y=1/(Q_{REF1}−Qₛₐₘₚₗₑ)

a=1/C_{LEV,REF3}

b=1/(Q_{REF1}−Q_{REF3})

c=1/C_{LEV,REF2}

d=1/(Q_{REF1}−Q_{REF2})

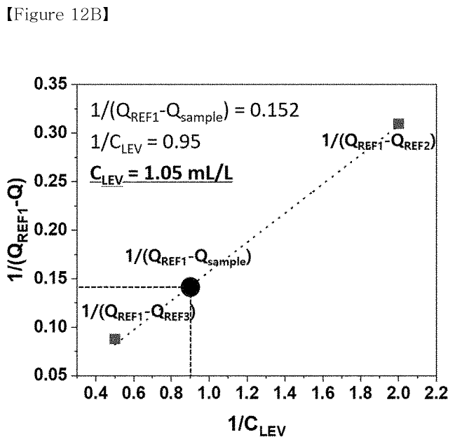

The results are shown in FIGS. 12A and 12B. FIGS. 12A and 12B are graphs showing the result of measuring the concentration of a leveler in an unknown sample according to one embodiment of the present invention.

Although the present invention has been described in detail through specific exemplary embodiments, the exemplary embodiments are provided to specifically describe the present invention and not to limit the present invention thereto, and it is apparent that modifications and improvement can be made by those skilled in the art within the technical spirit of the present invention. All simple modifications or alterations of the present invention are encompassed in the scope of the present invention, and the specific protection scope of the present invention will become apparent by the appended claims.

### DESCRIPTION OF REFERENCE NUMERALS

100, 100′, 100a, 100b, 100c: measuring cell 112: supply unit
114: discharge unit 120: working electrode
130: reference electrode 140: counter electrode
200, 200′, 200″: supply member 210, 210′, 210″: supply line
220, 220′, 220″: selection valve 230, 230′, 230″: pump
240, 240′: Y-connector 300, 300′, 300a, 300b, 300c: measuring unit
400, 400′, 400″: control unit

1. An electrochemical measuring cell comprising:
a flow cell including a supply unit through which a plating solution is supplied and a discharge unit through which the plating solution is discharged;
a working electrode coming into contact with the plating solution accommodated in the flow cell;
a reference electrode coming into contact with the plating solution accommodated in the flow cell and thus serving as a reference when determining the electrochemical potential of the working electrode; and
a counter electrode coming into contact with the plating solution accommodated in the flow cell,
wherein the working electrode is an anode and includes a precious metal film, and anodic current or potential is measured at the working electrode to identify the concentration of an additive breakdown product during a plating process.

2. The electrochemical measuring cell of claim 1, wherein the working electrode is gold (Au) or a precious metal alloy thereof, or the surface thereof is covered with Au or a precious metal alloy thereof or includes Au or a precious metal alloy thereof in particle form.

3.The electrochemical measuring cell of claim 1, wherein the plating process is a copper plating process.

4. The electrochemical measuring cell of claim 1, wherein a reference plating solution includes copper sulfate, sulfuric acid, and hydrochloric acid.

5. The electrochemical measuring cell of claim 1, wherein the additive breakdown product is monovalent copper ions or a complex thereof.

6. The electrochemical measuring cell of claim 1, wherein the additive breakdown product is 3-mercaptopropyl sulfonate (MPS).

7. The electrochemical measuring cell of claim 1, wherein the additive breakdown product is Cu⁺-MPS.

8. The electrochemical measuring cell of claim 1, wherein the additive includes sodium sulfopropyl disulfide (SPS).

9. The electrochemical measuring cell of claim 1, wherein the plating solution is directly supplied from a plating bath where plating is in progress.

10. The electrochemical measuring cell of claim 1, wherein, in the supply unit, one or more plating solutions of a reference plating solution and a sample plating solution are selectively supplied.

11. An electrochemical measuring device comprising:
the electrochemical measuring cell of claim 1; and
a measuring unit for measuring anodic current or potential at the working electrode to determine the concentration of an additive breakdown product in a plating solution.

12. The electrochemical measuring device of claim 11, further comprising a selection valve for selectively supplying one or more of a reference plating solution and a sample plating solution.

13. The electrochemical measuring device of claim 11, further comprising a control unit for controlling the supply of a plating solution to the flow cell and monitoring the performance of the plating solution by detecting an additive component of the plating solution by receiving a signal from the measuring unit.

14. The electrochemical measuring device of claim 11, further comprising:
one or more of the flow cells; and
one or more measuring units paired with the flow cells.

15. An electrochemical measuring system comprising:
the electrochemical measuring cell of claim 1;
a measuring unit for measuring anodic current or potential at the working electrode to determine the concentration of an additive breakdown product in a plating solution; and
a processing device for determining the concentration of an additive breakdown product based on the measured anodic current or potential.
